(19) United States
(12) Patent Application Publication
(10) Pub. No.: US 2025/0024512 A1
(43) Pub. Date: Jan. 16, 2025

(54) CELL AND TIMING ADVANCE GROUP INDICATIONS FOR RANDOM ACCESS PROCEDURES

(71) Applicant: QUALCOMM Incorporated, San Diego, CA (US)

(72) Inventors: Shaozhen GUO, Beijing (CN); Mostafa KHOSHNEVISAN, San Diego, CA (US); Fang YUAN, Beijing (CN); Yan ZHOU, San Diego, CA (US); Jing SUN, San Diego, CA (US); Xiaoxia ZHANG, San Diego, CA (US); Tao LUO, San Diego, CA (US); Peter GAAL, San Diego, CA (US)

(21) Appl. No.: 18/717,063

(22) PCT Filed: Feb. 16, 2022
(86) PCT No.: PCT/CN2022/076407

§ 371 Date: Jun. 6, 2024

(51) Int. Cl. H04W 74/0833; H04W 72/0453; H04W 72/23

(52) U.S. Cl. CPC H04W 74/0833; H04W 72/0453; H04W 72/23

(57) ABSTRACT

Various aspects of the present disclosure generally relate to wireless communication. In some aspects, a user equipment (UE) may receive, in a first cell, a physical downlink control channel (PDCCH) order, wherein the PDCCH order includes an indication identifying a second cell to which the PDCCH order applies, wherein the second cell is different from the first cell, and wherein the PDCCH order triggers a random access procedure associated with the second cell. The UE may perform the random access procedure associated with the second cell based at least in part on the PDCCH order. Numerous other aspects are described.

### FIELD OF THE DISCLOSURE

Aspects of the present disclosure generally relate to wireless communication and to techniques and apparatuses for cell and timing advance group indications for random access procedures.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, in a first cell, a physical downlink control channel (PDCCH) order, wherein the PDCCH order includes an indication identifying a second cell to which the PDCCH order applies, wherein the second cell is different from the first cell, and wherein the PDCCH order triggers a random access procedure associated with the second cell. The method may include performing the random access procedure associated with the second cell based at least in part on the PDCCH order.

Some aspects described herein relate to a method of wireless communication performed by a UE. The method may include transmitting, in a cell associated with multiple timing advance groups (TAGs), a random access preamble communication associated with a random access procedure. The method may include receiving, in response to the random access preamble communication, a random access response (RAR) communication, wherein the RAR communication includes an indication of a timing advance command (TAC). The method may include determining a corresponding TAG, of the multiple TAGs, associated with the TAC. The method may include adjusting, based at least in part on the TAC, a timing advance parameter associated with the corresponding TAG.

Some aspects described herein relate to an apparatus for wireless communication at a UE. The apparatus may include a memory and one or more processors coupled to the memory. The one or more processors may be configured to receive, in a first cell, a PDCCH order, wherein the PDCCH order includes an indication identifying a second cell to which the PDCCH order applies, wherein the second cell is different from the first cell, and wherein the PDCCH order triggers a random access procedure associated with the second cell. The one or more processors may be configured to perform the random access procedure associated with the second cell based at least in part on the PDCCH order.

Some aspects described herein relate to an apparatus for wireless communication at a UE. The UE may include a memory and one or more processors coupled to the memory. The one or more processors may be configured to transmit, in a cell associated with multiple TAGs, a random access preamble communication associated with a random access procedure. The one or more processors may be configured to receive, in response to the random access preamble communication, an RAR communication, wherein the RAR communication includes an indication of a TAC. The one or more processors may be configured to determine a corresponding TAG, of the multiple TAGs, associated with the TAC. The one or more processors may be configured to adjust, based at least in part on the TAC, a timing advance parameter associated with the corresponding TAG.

Some aspects described herein relate to a non-transitory computer-readable medium that stores a set of instructions for wireless communication by a UE. The set of instructions, when executed by one or more processors of the UE, may cause the UE to receive, in a first cell, a PDCCH order, wherein the PDCCH order includes an indication identifying a second cell to which the PDCCH order applies, wherein the second cell is different from the first cell, and wherein the PDCCH order triggers a random access procedure associated with the second cell. The set of instructions, when executed by one or more processors of the UE, may cause the UE to perform the random access procedure associated with the second cell based at least in part on the PDCCH order.

Some aspects described herein relate to a non-transitory computer-readable medium that stores a set of instructions for wireless communication by a UE. The set of instructions, when executed by one or more processors of the UE, may cause the UE to transmit, in a cell associated with multiple TAGs, a random access preamble communication associated with a random access procedure. The set of instructions, when executed by one or more processors of the UE, may cause the UE to receive, in response to the random access preamble communication, an RAR communication, wherein the RAR communication includes an indication of a TAC. The set of instructions, when executed by one or more processors of the UE, may cause the UE to determine a corresponding TAG, of the multiple TAGs, associated with the TAC. The set of instructions, when executed by one or more processors of the UE, may cause the UE to adjust, based at least in part on the TAC, a timing advance parameter associated with the corresponding TAG.

Some aspects described herein relate to an apparatus for wireless communication. The apparatus may include means for receiving, in a first cell, a PDCCH order, wherein the PDCCH order includes an indication identifying a second cell to which the PDCCH order applies, wherein the second cell is different from the first cell, and wherein the PDCCH order triggers a random access procedure associated with the second cell. The apparatus may include means for performing the random access procedure associated with the second cell based at least in part on the PDCCH order.

Some aspects described herein relate to an apparatus for wireless communication. The apparatus may include means for transmitting, in a cell associated with multiple TAGs, a random access preamble communication associated with a random access procedure. The apparatus may include means for receiving, in response to the random access preamble communication, an RAR communication, wherein the RAR communication includes an indication of a TAC. The apparatus may include means for determining a corresponding TAG, of the multiple TAGs, associated with the TAC. The apparatus may include means for adjusting, based at least in part on the TAC, a timing advance parameter associated with the corresponding TAG.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a disaggregated base station architecture, in accordance with the present disclosure.

FIG. 4 is a diagram illustrating examples of carrier aggregation, in accordance with the present disclosure.

FIG. 5 is a diagram illustrating an example of a multi-transmit receive point (TRP) scenario, in accordance with the present disclosure.

FIG. 6 is a diagram illustrating an example of a four-step, contention free random access (CFRA) procedure, in accordance with the present disclosure.

FIG. 7 is a diagram illustrating an example of a four-step, CFRA procedure, in accordance with the present disclosure.

FIG. 8 is a diagram illustrating an example process performed, for example, by a UE, in accordance with the present disclosure.

FIG. 9 is a diagram illustrating an example process performed, for example, by a UE, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

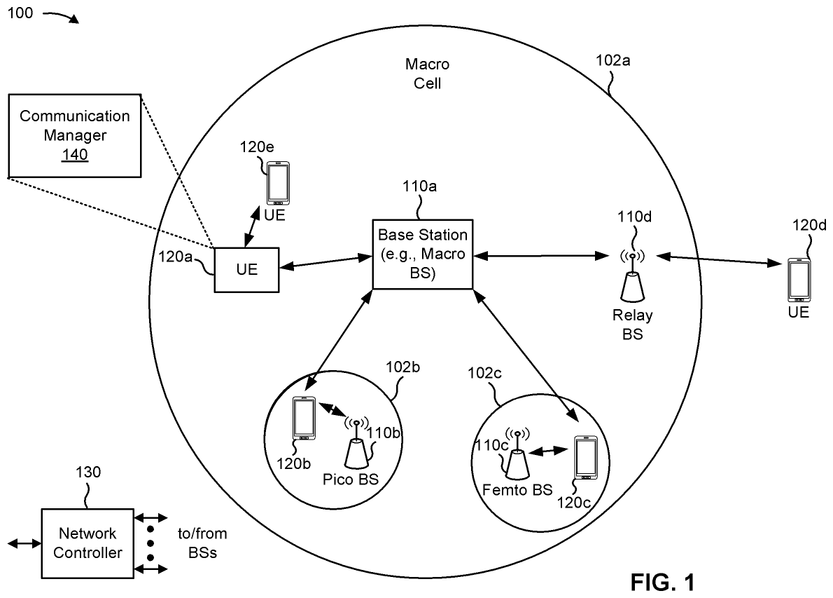

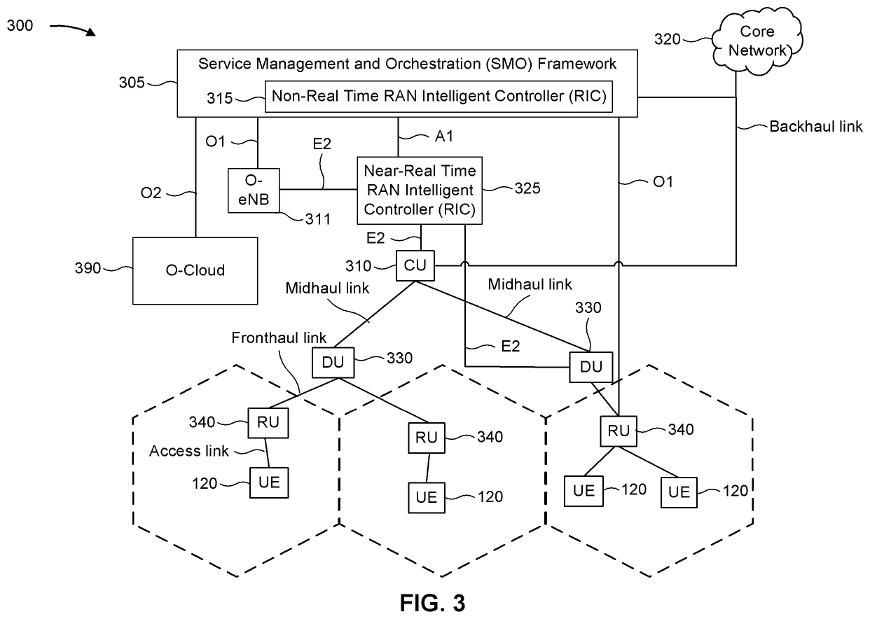

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Moreover, although depicted as an integral unit in FIG. 1, aspects of the disclosure are not so limited. In some other aspects, the functionality of the base station 110 may be disaggregated according to an open radio access network (RAN) (O-RAN) architecture or the like, which is described in more detail in connection with FIG. 3. Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, in a first cell, a physical downlink control channel (PDCCH) order, wherein the PDCCH order includes an indication identifying a second cell to which the PDCCH order applies, wherein the second cell is different from the first cell, and wherein the PDCCH order triggers a random access procedure associated with the second cell; and perform the random access procedure associated with the second cell based at least in part on the PDCCH order. Additionally, or alternatively, the communication manager 140 may transmit, in a cell associated with multiple timing advance groups (TAGs), a random access preamble communication associated with a random access procedure; receive, in response to the random access preamble communication, a random access response (RAR) communication, wherein the RAR communication includes an indication of a timing advance command (TAC); determine a corresponding TAG, of the multiple TAGs, associated with the TAC; and adjust, based at least in part on the TAC, a timing advance parameter associated with the corresponding TAG. Additionally, or alternatively, the communication manager 140 may perform one or more other operations described herein.

As indicated above, FIG. 1 is provided as an example. Other examples may differ from what is described with regard to FIG. 1.

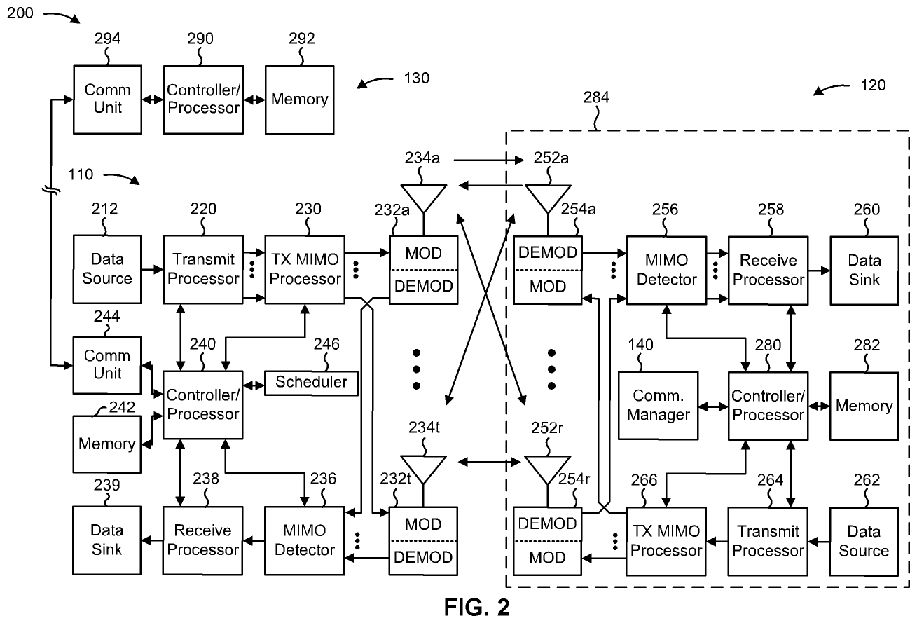

FIG. 2 is a diagram illustrating an example 200 of abase station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

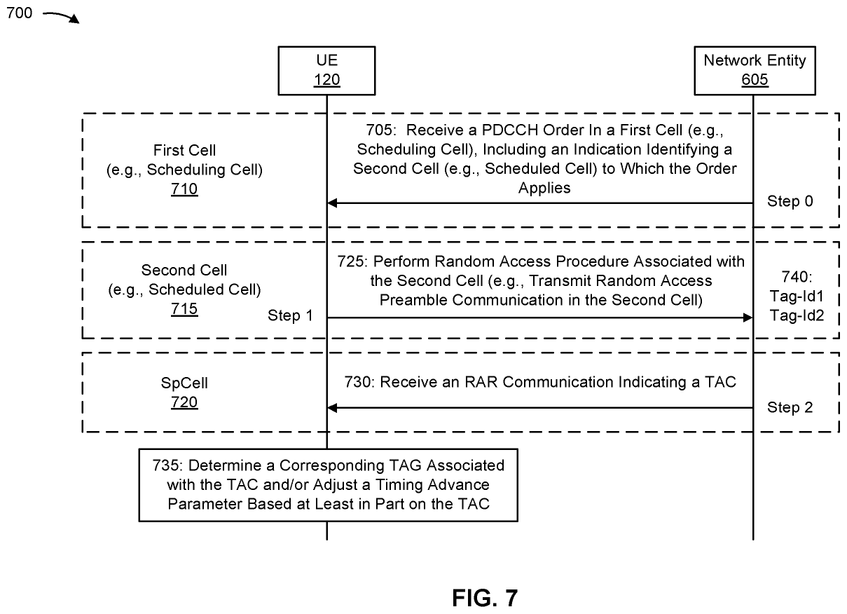

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-11).

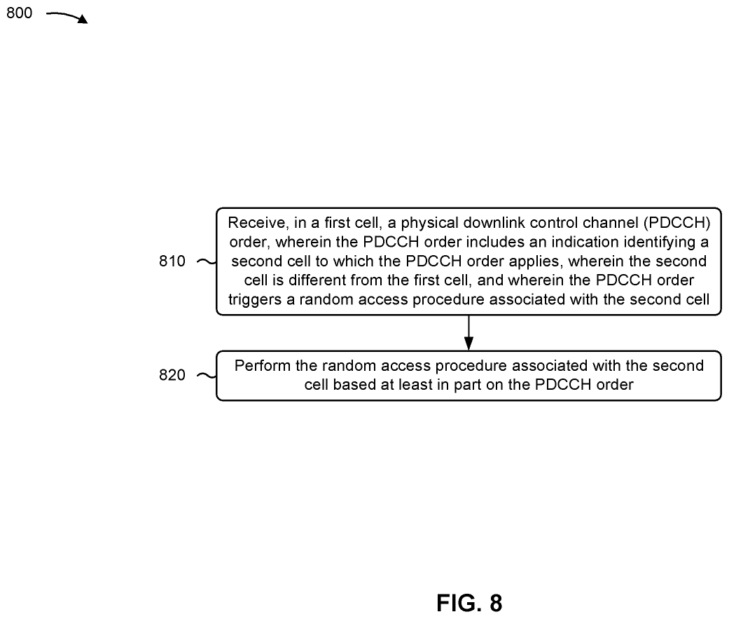

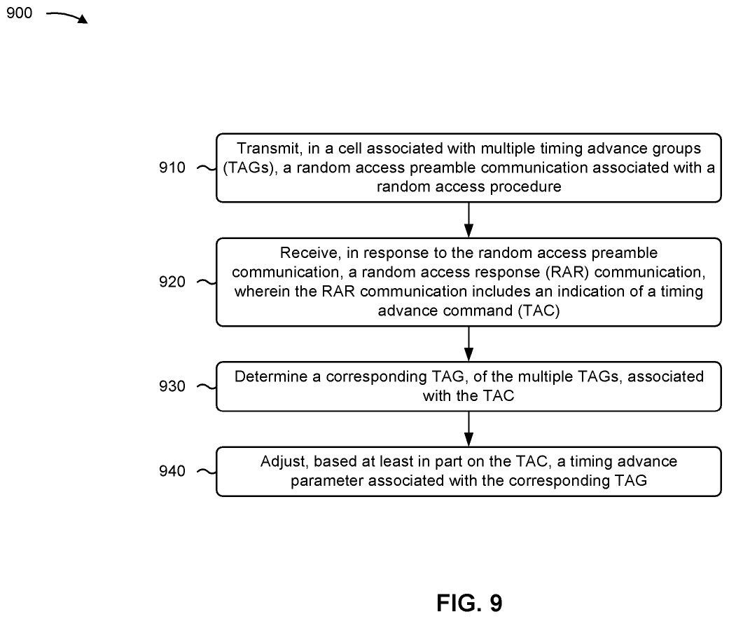

The controller/processor 240 of the base station 110, the controller/processor 280 of the UE 120, and/or any other component(s) of FIG. 2 may perform one or more techniques associated with cell and TAG indications for random access procedures, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving, in a first cell, a PDCCH order, wherein the PDCCH order includes an indication identifying a second cell to which the PDCCH order applies, wherein the second cell is different from the first cell, and wherein the PDCCH order triggers a random access procedure associated with the second cell; and/or means for performing the random access procedure associated with the second cell based at least in part on the PDCCH order. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for transmitting, in a cell associated with multiple TAGs, a random access preamble communication associated with a random access procedure; means for receiving, in response to the random access preamble communication, a RAR communication, wherein the RAR communication includes an indication of a TAC; means for determining a corresponding TAG, of the multiple TAGs, associated with the TAC; and/or means for adjusting, based at least in part on the TAC, a timing advance parameter associated with the corresponding TAG. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of a disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

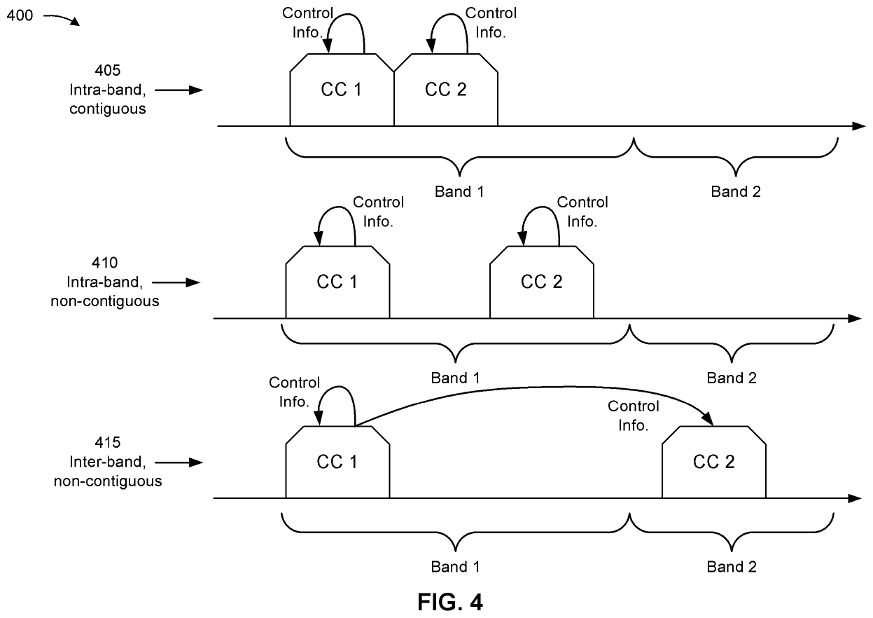

FIG. 4 is a diagram illustrating examples 400 of carrier aggregation, in accordance with the present disclosure.

Carrier aggregation enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A base station 110 or a similar network entity (e.g., a CU 310, a DU 330, or an RU 340) may configure carrier aggregation for a UE 120, such as in an RRC message, downlink control information (DCI), and/or another signaling message.

As shown by reference number 405, in some aspects, carrier aggregation may be configured in an intra-band contiguous mode where the aggregated carriers are contiguous to one another and are in the same band. As shown by reference number 410, in some aspects, carrier aggregation may be configured in an intra-band non-contiguous mode where the aggregated carriers are non-contiguous to one another and are in the same band. As shown by reference number 415, in some aspects, carrier aggregation may be configured in an inter-band non-contiguous mode where the aggregated carriers are non-contiguous to one another and are in different bands.

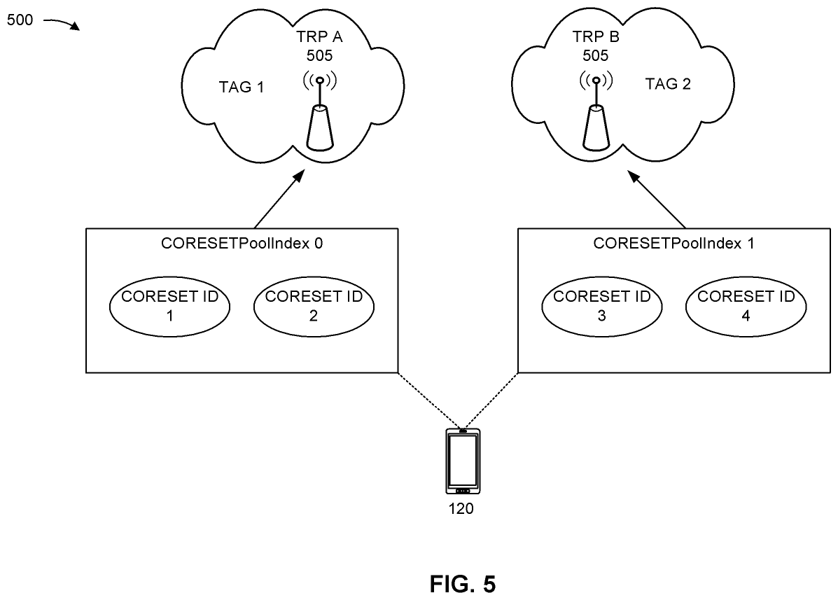

In carrier aggregation, a UE 120 may be configured with a primary carrier or primary cell (PCell) and one or more secondary carriers or secondary cells (SCells), which, in some aspects, may include a primary secondary cell (PSCell). The PCell and SCell may be referred to as serving cells. A serving cell is a cell on which a UE can transmit or receive data communications. In some aspects, an “SpCell” may refer to a PCell or a PSCell. An SpCell is a cell on which a UE can transmit or receive control signaling, random access channel (RACH) messages, or the like. In some aspects, a carrier (e.g., the primary carrier or one of the secondary carriers) may carry control information (e.g., downlink control information and/or scheduling information) for scheduling data communications on one or more other carriers (e.g., one or more other secondary carriers), which may be referred to as cross-carrier scheduling. For example, the inter-band, non-contiguous mode (as shown by reference number 415), the first carrier (e.g., CC 1) carries control information for both the first carrier and the second carrier (e.g., CC 2). The primary or secondary carrier that carries control information for another cell (e.g., CC 1 in the inter-band, non-contiguous mode shown in FIG. 4) is sometimes referred to as the scheduling cell, and other cell (e.g., CC 2 in the inter-band, non-contiguous mode shown in FIG. 4) is sometimes referred to as a scheduled cell. In some aspects, the scheduling cell may receive control information in a PDCCH, and, more particularly, within a control resource set (CORESET) associated with the PDCCH. Moreover, in some aspects, the scheduled cell may not be associated with a corresponding PDCCH and/or CORESET (e.g., the scheduling cell relies on the PDCCH and/or CORESET of the scheduling cell for receiving control information). Aspects of the CORESET are described in more detail in connection with FIG. 5.

In some aspects, a carrier (e.g., a primary carrier or a secondary carrier) may carry control information for scheduling data communications on the carrier, which may be referred to as self-carrier scheduling or carrier self-scheduling. For example, in the intra-band, contiguous mode and the intra-band, non-contiguous mode (shown by reference numbers 405 and 410, respectively, in FIG. 4), the first carrier (e.g., CC 1) carries control information for the first carrier and the second carrier (e.g., CC 2) carries control information for the second carrier. In self-carrier scheduling aspects, each cell may receive control information in a corresponding PDCCH, and, more particularly, within a CORESET associated with the corresponding PDCCH. Although the first two aspects in FIG. 4 (e.g., the intra-band, contiguous mode, as shown by reference number 405, and the intra-band, non-contiguous mode, as shown by reference number 410) are shown as implementing self-carrier scheduling and the third aspect (e.g., the inter-band, non-contiguous mode, as shown by reference number 415) is shown as implementing cross-carrier scheduling, aspects of the disclosure are not so limited. In some other aspects, one or both of the intra-band, contiguous mode (as shown by reference number 405) and the intra-band, non-contiguous mode (as shown by reference number 410) may implement cross-carrier scheduling, and/or the inter-band, non-contiguous mode (as shown by reference number 415) may implement self-carrier scheduling without departing from the scope of the disclosure.

As indicated above, FIG. 4 is provided as an example. Other examples may differ from what is described with regard to FIG. 4.

FIG. 5 is a diagram illustrating an example 500 of a multi-TRP scenario, in accordance with the present disclosure.

In some aspects, an access node and/or a cell (e.g., the PCell or one or more the SCells described above in connection with FIG. 4) may be associated with multiple TRPs 505 serving a UE 120. In some aspects, the multiple TRPs 505 may transmit communications (e.g., the same communication or different communications) in the same transmission time interval (TTI) (e.g., a slot, a mini-slot, a subframe, or a symbol) or different TTIs using different quasi co-location (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 505 may be configured to individually (e.g., using dynamic selection) or jointly (e.g., using joint transmission with one or more other TRPs 505) serve traffic to a UE 120.

In some aspects, the TRPs 505 may be associated with a common TAG for purposes of timing advance control procedures, while, in some other aspects, the TRPs 505 may be associated with different TAGs for purposes of timing advance control procedures. Timing advance control refers the control of uplink transmission timing at a UE (e.g., UE 120) to enable uplink transmissions from the UE to be synchronized when received by an access node or the like. Due to air-interface propagation delay or the like, an uplink transmission from the UE 120 will take longer to reach a relatively far away access node than an uplink transmission from the UE 120 takes to reach a relatively close access node. Thus, the access node may periodically configure one or more UEs with a TAC, which indicates an adjustment to a timing advance parameter associated with the UE in order to enable synchronized reception by the access node (e.g., such that the access node receives transmissions from the UE within a downlink radio frame, or the like). For example, more distant UEs from the access node may be configured with a longer timing advance parameter than UEs that are closer to the access node such that the uplink transmissions from both UEs will arrive at the access node at the same time and/or within a downlink radio frame.

In some aspects, network entities (e.g., base stations 110, DUs 330, RUs 340, TRPs 505, or the like) that are nearby to one another may experience similar air-interface propagation delays. Thus, such network entities may form part of a single TAG, meaning that the network entities share the same uplink transmission timing (e.g., they are subject to the same timing advance parameter). However, network entities that are geographically separated or otherwise relatively far from one another may experience different air-interface propagation delays, and thus are associated with different uplink transmission timings and thus different TAGs (e.g., they are subject to different timing advance parameters). For example, as shown in FIG. 5, in a multi-TRP scenario, a first TRP 505 (e.g., TRP A) may be associated with a first TAG (e.g., TAG 1), while a second TRP 505 (e.g., TRP B) may be associated with a second TAG (e.g., TAG 2). Thus, in aspects in which the TRPs 505 are associated with the same serving cell (e.g., one of the PCell or the SCell), the UE 120 may be configured with multiple TAGs (e.g., TAG 1 and TAG 2) for a single serving cell.

Moreover, in multi-TRP scenarios such as the one shown in FIG. 5, a CORESET pool index (or CORESETPoolIndex) value may be used by a UE (e.g., UE 120) to identify a TRP (e.g., TRP 505) associated with an uplink grant received on a PDCCH. A CORESET may refer to a control region that is structured to support an efficient use of resources, such as by flexible configuration or reconfiguration of resources for one or more PDCCHs associated with a UE. In some aspects, a CORESET may occupy the first symbol of an orthogonal frequency division multiplexing (OFDM) slot, the first two symbols of an OFDM slot, or the first three symbols of an OFDM slot. Thus, a CORESET may include multiple resource blocks (RBs) in the frequency domain, and either one, two, or three symbols in the time domain. In 5G, a quantity of resources included in a CORESET may be flexibly configured, such as by using RRC signaling to indicate a frequency domain region (for example, a quantity of resource blocks) or a time domain region (for example, a quantity of symbols) for the CORESET.

As illustrated in FIG. 5, a UE 120 may be configured with multiple CORESETs in a given serving cell. Each CORESET configured for the UE 120 may be associated with a CORESET identifier (CORESET ID). For example, a first CORESET configured for the UE 120 may be associated with CORESET ID 1, a second CORESET configured for the UE 120 may be associated with CORESET ID 2, a third CORESET configured for the UE 120 may be associated with CORESET ID 3, and a fourth CORESET configured for the UE 120 may be associated with CORESET ID 4.

As further illustrated in FIG. 5, two or more (for example, up to five) CORESETs may be grouped into a CORESET pool. Each CORESET pool may be associated with a CORESET pool index (sometimes referred to as a CORESETPoolIndex). As an example, CORESET ID 1 and CORESET ID 2 may be grouped into CORESETPoolIndex 0, and CORESET ID 3 and CORESET ID 4 may be grouped into CORESETPoolIndex 1. In a multi-TRP configuration, each CORESETPoolIndex value may be associated with a particular TRP 505. As an example, and as illustrated in FIG. 5, a first TRP 505 (TRP A) may be associated with CORESETPoolIndex 0 and a second TRP 505 (TRP B) may be associated with CORESETPoolIndex 1. The UE 120 may be configured by a higher layer parameter, such as PDCCH-Config, with information identifying an association between a TRP and a CORESETPoolIndex value assigned to the TRP. Accordingly, the UE may identify the TRP that transmitted a DCI uplink grant by determining the CORESET ID of the CORESET in which the PDCCH carrying the DCI uplink grant was transmitted, determining the CORESETPoolIndex value associated with the CORESET pool in which the CORESET ID is included, and identifying the TRP associated with the CORESET pool index value.

As indicated above, FIG. 5 is provided as an example. Other examples may differ from what is described with respect to FIG. 5.

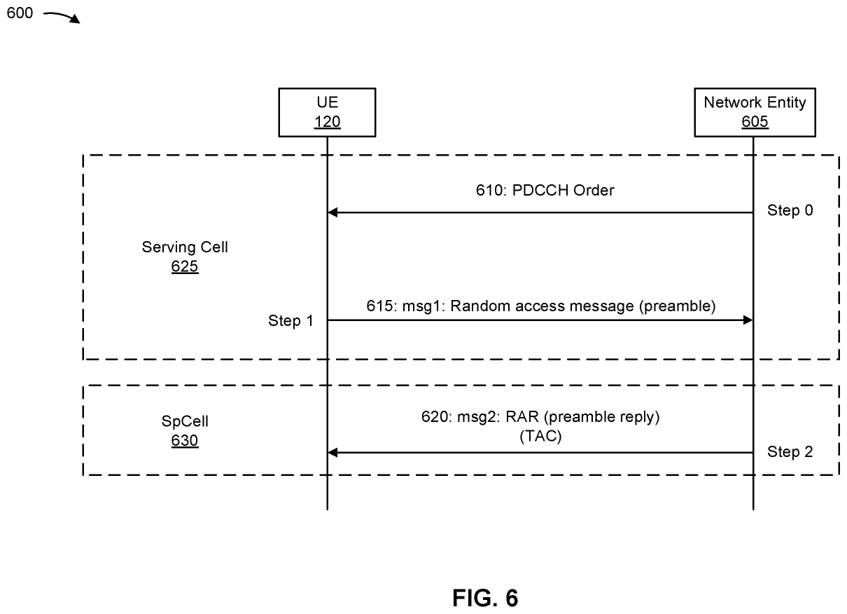

FIG. 6 is a diagram illustrating an example 600 of a four-step, contention free random access (CFRA) procedure, in accordance with the present disclosure. As shown in FIG. 6, a network entity 605 (e.g., a base station 110, a CU 310, a DU 330, an RU 340, a TRP 505, or the like) and a UE 120 may communicate with one another to perform the CFRA procedure.

The CFRA procedure shown in FIG. 6 may be used for purposes of configuring one or more cells (e.g., a PCell or one or more of the SCells described above in connection with FIG. 5) with one or more TACs to synchronize transmission timing or the like. That is, the CFRA procedure shown in FIG. 6 may be triggered by the network entity 605 based at least in part on the network entity 605 determining that a timing advance parameter for one or more cells needs to be updated and/or synchronized.

As shown by reference number 610, and as indicated as step 0, the network entity 605 may transmit, and the UE 120 may receive, a PDCCH order that triggers a RACH procedure, such as for contention-free random access (e.g., for the CFRA procedure). The random access configuration information may include one or more parameters to be used in the CFRA procedure, such as one or more parameters for transmitting a random access message (RAM) and/or one or more parameters for receiving a RAR.

As shown by reference number 615, and as indicated as step 1, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 620, and as indicated as step 2, the base station 110 may transmit an RAR as a reply to the preamble. The UE 120 may monitor a PDCCH for an RAR identified by a random access radio network temporary identifier (RA-RNTI) during a configured time window (sometimes referred to as ra-ResponseWindow) after transmitting the preamble communication at step 1. The message that includes the RAR may be referred to as message 2, msg2, MSG2, or a second message in a four-step random access procedure. In some aspects, the RAR may indicate, in a physical downlink shared channel (PDSCH) associated with the RAR or the like, the detected random access preamble identifier (e.g., received from the UE 120 in msg1), and/or a TAC for purposes of establishing and/or adjusting a timing advance parameter associated with a cell. The remaining steps of a four-step random access procedure (e.g., steps 3 and 4) may be used for purposes of collision resolution in a contention based random access (CBRA) procedure, and thus may not be applicable to the CFRA procedure described herein.

In some aspects, the PDCCH order shown by reference number 610 may be used to trigger a CFRA on a serving cell 625 (e.g., SpCell or SCell) to establish a timing advance parameter and/or adjust a timing advance parameter associated with a TAG. More particularly, each serving cell may be linked to a specific TAG by including a TAG identifier (sometimes referred to as a tag-Id) within the configured serving cell parameters (sometimes referred to as ServingCellConfig). A TAG that includes the SpCell (PCell or PSCell) is sometimes referred to as the primary TAG (PTAG), while other TAGs (e.g., TAGs including one or more SCells) are sometimes referred to as STAGs. The network entity 605 may initiate a CFRA procedure to establish a timing advance parameter and/or adjust a timing advance parameter for a PTAG or STAG by transmitting the PDCCH order (e.g., step 0) on a scheduling cell of an activated serving cell 625 of the PTAG or STAG. In some aspects, the PDCCH order may trigger the CFRA procedure by including a random access preamble index (sometimes referred to as ra-Preamblelndex) that is different from 0b000000, and/or by using a DCI format 1_0 that includes a frequency domain resource assignment (FDRA) field of all ones and a cyclic redundancy check (CRC) that is scrambled with a cell radio network temporary identifier (C-RNTI) associated with the UE 120. The PDCCH order may include certain indications indicating various parameters for the CFRA procedure, such as an uplink supplementary uplink (UL/SUL) indicator that indicates whether an uplink carrier or a supplementary uplink carrier should be used to transmit the PRACH communication, a synchronization signal/physical broadcast channel (SS/PBCH) index and a PRACH mask index that together indicate which RACH occasion should be used to transmit the PRACH communication, and/or a number (e.g., ten or twelve) of reserved bits. The UE 120 then transmits the PRACH communication (e.g., step 1) on the indicated serving cell 625 (e.g., SpCell or SCell), and receives the RAR (e.g., step 2) on an SpCell 630 (e.g., PCell or PSCell). The RAR may include a TAC, which, in this case, the UE 120 may use to adjust a timing advance parameter associated with a serving cell where the PRACH communication was transmitted (e.g., the serving cell 625).

Although the procedure described above may be used to trigger a CFRA on an SCell to establish timing advance for a STAG or establish UL synchronization for DL or UL data arrival during RRC_CONNECTED when UL synchronisation status is “non-synchronised” for a serving cell (e.g., an SpCell or SCell), the procedure may be inadequate for adjusting a timing advance parameter for an SCell configured with cross-carrier scheduling, which does not itself carry control information, and/or for adjusting a timing advance parameter for an serving cell associated with multiple TAGs, such as when the serving cell is associated with multiple TRPs. More particularly, as described in connection with FIG. 4, for an SCell configured with cross-carrier scheduling, control information is carried by a different cell (e.g., a scheduling cell) than the SCell, with the SCell (e.g., the scheduled cell) not being associated with a PDCCH and/or a CORESET. Thus, the cross-carrier scheduled SCell cannot itself receive a PDCCH order triggering the CFRA procedure described above. Moreover, if a PDCCH order is sent in the scheduling cell, the UE would not know which scheduled cell the PDCCH order corresponds to because the PDCCH order does not include a carrier indication field or the like. Additionally, as described in connection with FIG. 5, the serving cell 625 may be associated with multiple TAGs, such as when the serving cell 625 includes multiple TRPs, each associated with a different TAG (e.g., such as TRPs A and B described in connection with FIG. 5, associated with TAG 1 and TAG 2, respectively). However, because the RAR does not include a TAG identifier or the like, the UE 120 may not know to which TAG the TAC included in the RAR applies. Accordingly, timing advance parameters for SCells configured with cross-carrier scheduling and/or associated with multiple TAGs cannot be adjusted using the above described CFRA procedure, resulting in unsynchronized and/or interfering communications and thus degraded link quality, increased latency, decreased throughput, and inefficient network usage.

Some techniques and apparatuses described herein enable the use of a random access procedure to establish and/or adjust a timing advance parameter for an SCell configured with cross-carrier scheduling and/or to establish and/or adjust a timing advance parameter for a serving cell associated with multiple TAGs. In some aspects, a PDCCH order triggering a random access procedure (e.g., a CFRA procedure) for purposes of establishing and/or adjusting a timing advance parameter for a scheduled cell may be transmitted to a UE on a scheduling cell that is different from the scheduled cell to which the random access procedure applies. The PDCCH order may indicate that the PDCCH order applies to scheduled cell based at least in part on a carrier identification field included in the PDCCH order or the like. Additionally, or alternatively, in some aspects a PDCCH order may trigger a random access procedure (e.g., a CFRA procedure) for purposes of establishing and/or adjusting a timing advance parameter associated with one TAG of multiple TAGs associated with a serving cell. In some aspects, the UE may determine a corresponding TAG, of the multiple TAGs associated with the serving cell, to which a TAC indicated by an RAR applies. In some aspects, the UE may determine the corresponding TAG according to a configured or a hard-coded rule. In some other aspects, the UE may determine the corresponding TAG based at least in part on the corresponding TAG being associated with at least one of a CORESET pool index of a CORESET in which the PDCCH order is transmitted, a TCI state of the CORESET in which the PDCCH order is transmitted, an SS/PBCH index indicated by the PDCCH order, or a PRACH occasion indicated by the PDCCH order. In some other aspects, the UE may determine the corresponding TAG based at least in part a TAG indication included in one of the PDCCH order or the RAR. As a result, timing advance parameters for cells configured with cross-carrier scheduling and/or for cells associated with multiple TAGs may be adjusted using a CFRA procedure, resulting in synchronized communications, improved link quality, decreased latency, increased throughput, and overall efficient network usage.

As indicated above, FIG. 6 is provided as an example. Other examples may differ from what is described with regard to FIG. 6.

FIG. 7 is a diagram illustrating an example 700 of a four-step, CFRA procedure, in accordance with the present disclosure. As shown in FIG. 7, a network entity 605 (e.g., a base station 110, a CU 310, a DU 330, an RU 340, a TRP 505, or the like) and a UE 120 may communicate with one another to perform the CFRA procedure.

As shown by reference number 705, the UE 120 may receive, from the network entity 605, a PDCCH order triggering a CFRA procedure used to establish and/or adjust a timing advance parameter associated with a TAG, such as for an STAG, a PTAG, or the like. In some aspects, the PDCCH order is received in a first cell 710 and may include an indication identifying a second cell 715 to which the PDCCH order applies. In some aspects, the first cell 710 is a scheduling cell, and the second cell 715 is a scheduled cell. Moreover, in some aspects, the first cell 710 is the same as the second cell 715, such as for aspects in which the first cell 710 is configured for self-carrier scheduling. In some other aspects, the first cell 710 is different than the second cell 715, such as for aspects in which the second cell 715 is configured for cross-carrier scheduling. Moreover, the first cell 710 and/or the second cell 715 may be a PCell or an SCell. For example, in cross-carrier scheduling aspects, the first cell 710 (e.g., the scheduling cell) may be one of an SpCell or a first SCell, and the second cell 715 (e.g., the scheduled cell) may be a second SCell that is not configured with a PDCCH and/or a CORESET.

In some aspects, the PDCCH order may be associated with one of a DCI format 1_1 or a DCI format 1_2. In such aspects, the one of the DCI format 1_1 or the DCI format 1_2 may be identified as a PDCCH order according to information provided in one or more fields of the DCI. For example, when the one of the DCI format 1_1 or the DCI format 1_2 is used for the PDCCH order, the FDRA field of the DCI may be set as all ones, and/or a CRC of the DCI may be scrambled with a C-RNTI associated with the UE 120. Beneficially, the one of the DCI format 1_1 or the DCI format 1_2 may include a carrier indication field that indicates the serving cell to which the PDCCH order applies. Put another way, the indication identifying the second cell 715 as the serving cell to which the PDCCH order applies may be the carrier indication field of the one of the DCI format 1_1 or the DCI format 1_2. In some aspects, the carrier indication field may be 0 or 3 bits for a DCI format 11, or may be 0, 1, 2, or 3 bits for a DCI format 1_2. Additionally, or alternatively, in some aspects, the number of bits used for the carrier indication field may be determined by a carrier indicator size parameter (sometimes referred to as carrierlndicatorSizeDC1-1-2 for purposes of the DCI format 1_2) configured by RRC signaling or the like.

In some aspects, the one of the DCI format 1_1 or the DCI format 1_2 (e.g., the PDCCH order) may indicate additional parameters associated with the random access procedure. For example, the one of the DCI format 1_1 or the DCI format 1_2 may include an identifier for DCI formats (e.g., a one-bit identifier), an indication of a random access preamble index to be used for the preamble communication, a UL/SUL indicator indicating whether the UL or SUL should be used for the preamble communication, an SS/PBCH indicator indicating an SS/PBCH that should be used to determine a RACH occasion for the preamble communication, and/or a PRACH mask index that indicates the RACH occasion associated with the SS/PBCH indicated by the SS/PBCH indicator for the preamble communication. The one of the DCI format 1_1 or the DCI format 1_2 may also include additional, or reserved, bits, that may be unused for purposes of the PDCCH order.

In some other aspects, the PDCCH order may be associated with a DCI format 1_0. As described above in connection with reference number 610, when a DCI format 1_0 is used for purposes of the PDCCH order, the DCI format 1_0 may include an FDRA field of all ones and a CRC that is scrambled with the C-RNTI associated with the UE 120. Moreover, the DCI format 1_0 may indicate additional parameters associated with the random access procedure, such as, in a similar manner as described above in connection with the one of the DCI format 1_1 or the DCI format 1_2, an UL/SUL indicator, an SS/PBCH index, and/or a PRACH mask index. In this aspect, however, some of the reserved bits of the DCI format 1_0 may be used for purposes of identifying the second cell 715 to which the PDCCH order applies. More particularly, in some aspects, Xbits of the reserved bits of the DCI format 1_0 communication may be used as a carrier indication field, with Xbeing equal to 1, 2, or 3. In some aspects, the value ofXmay be configured using RRC signaling or the like.

As shown by reference number 725, the UE 120 may perform a random access procedure associated with the second cell 715 based at least in part on the PDCCH order indicated by reference number 705. For example, when the PDCCH order indicates that the second cell 715 is the serving cell to which the PDCCH order applies, the UE 120 may transmit a random access preamble communication in the second cell 715. As shown by reference number 730, the UE 120 may then receive, in the SpCell 720, an RAR communication. In some aspects, the SpCell 720 may correspond to the first cell 710 and/or the second cell 715, while, in some other aspects, the SpCell 720 may be different than the first cell 710 and the second cell 715. For example, in aspects in which the random access procedure is used to establish and/or adjust a timing advance parameter associated with an SCell configured for cross-carrier scheduling, the first cell 710 may be a first SCell (e.g., a scheduling cell), the second cell 715 may be a second SCell different from the first SCell (e.g., a scheduled cell of the first SCell), and the SpCell 720 may be a third cell different from the first cell 710 and the second cell 715.

In some aspects, the RAR communication may include, among other parameters or information, a TAC associated with the serving cell in which the preamble communication was transmitted (e.g., associated with the second cell 715). In some aspects, as shown by reference number 735, the UE 120 may adjust a timing advance parameter associated with the second cell 715 based at least in part on the TAC. For example, an initial TAC (sometimes referred to as T_{A}) may be associated with a number of bits in the RAR (e.g., 12 bits, indicating a value within the range from 0 to 3846). A timing advance parameter for the associated cell (sometimes referred to as T_{TA}) may then be determined based at least in part on the initial TAC (e.g., T_{A}). For example, in some aspects, an initial timing advance parameter for the cell (e.g., T_{TA}) may be equal to (N_{TA}+N_{TA_offset})×T_{C}, where N_{TA}=T_{A}×16×64/2^{μ}, with p being the subcarrier spacing index; where N_{TA_offset} is a predetermined offset based at least in part on certain parameters for the cell such as frequency range, duplex mode (e.g., time domain duplexing (TDD) or frequency domain duplexing (FDD)), and/or coexistence with another RAT; and where T_{C} is the sampling time for the cell, which is equal to 1/(Δfₘₐₓ×N_{f}) (e.g., 0.509 ns for a scenario of Δfₘₐₓ=480,000 Hz and Nf=4096). The timing advance parameter for the cell may thereafter be updated (sometimes referred to as T_{TA} new) if the UE 120 receives an updated TAC (e.g., T_{A} new) via the above-described random access procedure, with the updated timing advance parameter (e.g., T_{TA} new) equal to (N_{TA_new}+N_{TA_offset})×T_{C}, where N_{TA_new}=N_{TA_old}+(T_{A_new}−31)×16×64/2^{μ}.

In some aspects, a serving cell in which the preamble communication is transmitted may be associated with multiple TAGs, such as when the serving cell includes two TRPs (e.g., TRP A and TRP B shown in FIG. 5), with each TRP being associated with a different TAG (e.g., TAG 1 and TAG 2, respectively, in FIG. 5). For example, as shown by reference number 740, the second cell 715 may be associated with two TAGs corresponding to two TAG identifiers (e.g., Tag-Id1 and Tag-Id2). In this case, the first cell 710 and the second cell 715 may be the same cell, which may be the same cell or a different cell than the SpCell 720. In such aspects, as shown by reference number 735, the UE 120 may determine a corresponding TAG, of the multiple TAGs, associated with the TAC, and adjust, based at least in part on the TAC, a timing advance parameter associated with the corresponding TAG.

In some aspects, the UE 120 may determine the corresponding TAG associated with the TAC based at least in part on a hard-coded rule or the like. Put another way, the UE 120 may apply the TAC received in the RAR to a fixed TAG. In some aspects, the corresponding TAG (e.g., the fixed TAG) may be a first TAG of the serving cell where the random access preamble is transmitted. For example, the second cell 715 may be configured with two TAG identifiers, as shown by reference number 740 (e.g., Tag-Id1 and Tag-Id2), and the corresponding TAG associated with the TAC may be, by rule, a firstly configured TAG (e.g., a TAG associated with a first logical TAG identifier of the two TAG identifiers). Additionally, or alternatively, the corresponding TAG (e.g., the fixed TAG) may be, by rule, a numerically lowest TAG of the cell where the random access preamble is transmitted. Thus, for the depicted example, the UE 120 may determine that the the corresponding TAG is the TAG associated with Tag-Id1. Additionally, or alternatively, the corresponding TAG may be, by rule, a PTAG (e.g., in aspects in which one of the two TAGs associated with the serving cell is a PTAG while the other is associated with an STAG). Additionally, or alternatively, the corresponding TAG may be, by rule, a TAG associated with a CORESETPoolIndex 0. For example, in the example depicted in FIG. 5, the TRP A is associated with the CORESETPoolIndex 0, and thus TAG 1, which is associated with TRP A, may be determined to be the corresponding TAG.

In some other aspects, the corresponding TAG may be determined based at least in part on a CORESET in which the PDCCH order is received. For example, in some aspects, if the PDCCH order is received in a CORESET associated with the CORESETPoolIndex 0 (e.g., CORSET ID 1 or CORSET ID 2 in FIG. 5), or else is received in a CORESET not associated with a CORESETPoolIndex, the corresponding TAG may be a first TAG of the multiple TAGs associated with the serving cell and/or a TAG associated with the CORESETPoolIndex 0 (e.g., TAG 1 in FIG. 5). Similarly, if the PDCCH order is received in a CORESET associated with the CORESETPoolIndex 1 (e.g., CORSET ID 3 or CORSET ID 4 in FIG. 5), the corresponding TAG may be a second TAG of the multiple TAGs associated with the serving cell and/or a TAG associated with the CORESETPoolIndex 1 (e.g., TAG 2 in FIG. 5).

In some aspects, the corresponding TAG may be determined based at least in part on a TCI state that is associated with the CORESET in which the PDCCH order is received. For example, if the TCI state of the CORESET in which the PDCCH order is received belongs to a first half of TCI states in a PDCCH TCI list associated with the serving cell (e.g., TCI states 1-32), the corresponding TAG may be a first TAG of the multiple TAGs associated with the cell. Similarly, if the TCI state of the CORESET in which the PDCCH order is received belongs to a second half of TCI states in a PDCCH TCI list associated with the cell (e.g., TCI states 33-64), the corresponding TAG may be a second TAG of the multiple TAGs associated with the cell.

In some aspects, the corresponding TAG may be determined based at least in part on an SS/PBCH index and/or PRACH occasions indicated by the PDCCH order. For example, if the SS/PBCH index indicated by the PDCCH order belongs to a first half of SS/PBCH indexes in a PDCCH SS/PBCH list associated with a serving cell, the corresponding TAG may be a first TAG of the multiple TAGs associated with the serving cell, while if the SS/PBCH index belongs to a second half of SS/PBCH indexes in a PDCCH SS/PBCH list associated with a serving cell, the corresponding TAG may be a second TAG of the multiple TAGs associated with the serving cell. Similarly, if the PRACH occasion indicated by the PDCCH order (as determined from the indicated SS/PBCH index together with the indicated PRACH mask index) belongs to a first half of PRACH occasions associated with a serving cell, the corresponding TAG may be a first TAG of the multiple TAGs associated with the serving cell, while if the indicated PRACH occasion belongs to a second half of PRACH occasions associated with a serving cell, the corresponding TAG may be a second TAG of the multiple TAGs associated with the serving cell.

In some aspects, the corresponding TAG may be determined based at least in part on an indicator included in at least one of the PDCCH order or the RAR. For example, the PDCCH order may include a TAG indication field that indicates the corresponding TAG of the multiple TAGs to which the TAC applies. The TAG indication field of the PDCCH order may be indicated using a number of reserved bits of the corresponding DCI (e.g., the one of the DCI format 1_0, DCI format 11, or DCI format 1_2). Additionally, or alternatively, the TAG indication field may be included in the RAR. In such aspects, the corresponding TAG may be indicated using a reserved bit in the RAR PDSCH. For example, if the reserved bit is set to 0, then the corresponding TAG may be a first TAG of the multiple TAGs associated with the serving cell. And if the reserved bit is set to 1, then the corresponding TAG may be a second TAG of the multiple TAGs associated with the serving cell.

Once the UE 120 determines which TAG of the multiple TAGs the TAC applies to, the UE 120 may adjust a timing advance parameter associated with the corresponding TAG based at least in part on the TAC, in a similar manner as described above in connection with reference number 735. More particularly, a timing advance parameter for the associated TAG (e.g., T_{TA}) may be established based at least in part on an initially received TAC (e.g., T_{A}) as equal to (N_{TA}+N_{TA_offfset})×T_{C}, and/or an updated timing advance parameter (e.g., T_{TA} new) may be determined if an updated TAC (e.g., T_{A_new}) is thereafter received, which may be equal to (N_{TA_new}+N_{TA_offset})×T_{C}, where N_{TA_new}=N_{TA_old}+(T_{A_new}−31)×16×64/2^{μ}.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with cell and TAG indications for random access procedures.

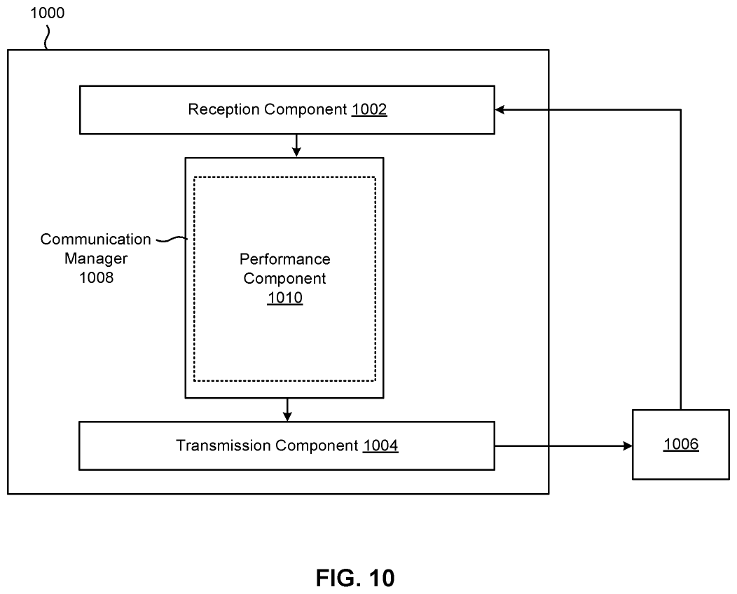

As shown in FIG. 8, in some aspects, process 800 may include receiving, in a first cell, a PDCCH order, wherein the PDCCH order includes an indication identifying a second cell to which the PDCCH order applies, wherein the second cell is different from the first cell, and wherein the PDCCH order triggers a random access procedure associated with the second cell (block 810). For example, the UE (e.g., using communication manager 1008 and/or reception component 1002, depicted in FIG. 10) may receive, in a first cell, a PDCCH order, wherein the PDCCH order includes an indication identifying a second cell to which the PDCCH order applies, wherein the second cell is different from the first cell, and wherein the PDCCH order triggers a random access procedure associated with the second cell, as described above.

As further shown in FIG. 8, in some aspects, process 800 may include performing the random access procedure associated with the second cell based at least in part on the PDCCH order (block 820). For example, the UE (e.g., using communication manager 1008 and/or performance component 1010, depicted in FIG. 10) may perform the random access procedure associated with the second cell based at least in part on the PDCCH order, as described above.

Process 800 may include additional aspects, such as any single aspect or any combination of aspects described below and/or in connection with one or more other processes described elsewhere herein.

In a first aspect, the second cell is not configured with a CORESET or PDCCH.

In a second aspect, alone or in combination with the first aspect, the PDCCH order is associated with one of a DCI format 1_1 or a DCI format 1_2.

In a third aspect, alone or in combination with one or more of the first and second aspects, an FDRA field of the one of the DCI format 1_1 or the DCI format 1_2 is set as all ones.

In a fourth aspect, alone or in combination with one or more of the first through third aspects, a CRC of the one of the DCI format 1_1 or the DCI format 1_2 is scrambled with a C-RNTI associated with the UE.

In a fifth aspect, alone or in combination with one or more of the first through fourth aspects, the one of the DCI format 1_1 or the DCI format 1_2 indicates at least one of a random access preamble index, an uplink/supplemental uplink indicator, an SS/PBCH indicator, or a PRACH mask index.

In a sixth aspect, alone or in combination with one or more of the first through fifth aspects, the one of the DCI format 1_1 or the DCI format 1_2 includes a carrier indication field, and the indication identifying the second cell is the carrier indication field.

In a seventh aspect, alone or in combination with one or more of the first through sixth aspects, the PDCCH order is associated with a DCI format 1_0.

In an eighth aspect, alone or in combination with one or more of the first through seventh aspects, the indication identifying the second cell is indicated using a number of reserved bits of the DCI format 1_0.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., UE 120) performs operations associated with cell and TAG indications for random access procedures.

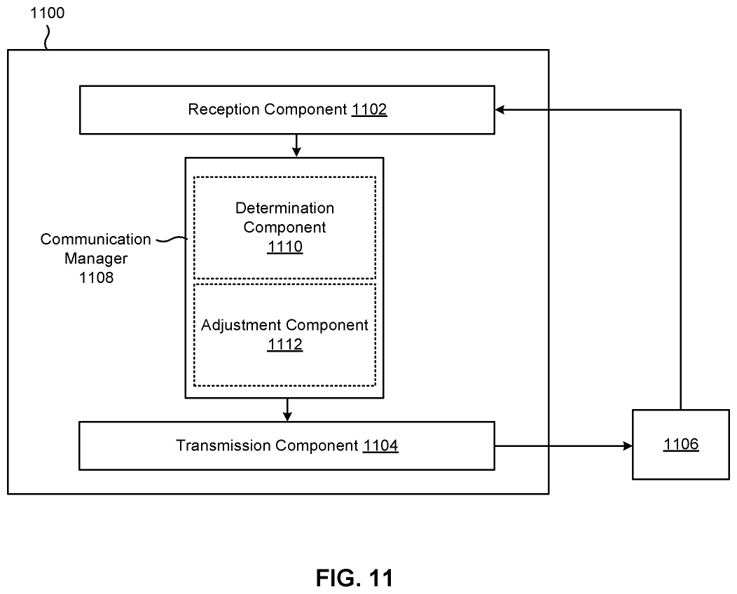

As shown in FIG. 9, in some aspects, process 900 may include transmitting, in a cell associated with multiple TAGs, a random access preamble communication associated with a random access procedure (block 910). For example, the UE (e.g., using communication manager 1108 and/or transmission component 1104, depicted in FIG. 11) may transmit, in a cell associated with multiple TAGs, a random access preamble communication associated with a random access procedure, as described above.

As further shown in FIG. 9, in some aspects, process 900 may include receiving, in response to the random access preamble communication, an RAR communication, wherein the RAR communication includes an indication of a TAC (block 920). For example, the UE (e.g., using communication manager 1108 and/or reception component 1102, depicted in FIG. 11) may receive, in response to the random access preamble communication, an RAR communication, wherein the RAR communication includes an indication of a TAC, as described above.

As further shown in FIG. 9, in some aspects, process 900 may include determining a corresponding TAG, of the multiple TAGs, associated with the TAC (block 930). For example, the UE (e.g., using communication manager 1108 and/or determination component 1110, depicted in FIG. 11) may determine a corresponding TAG, of the multiple TAGs, associated with the TAC, as described above.

As further shown in FIG. 9, in some aspects, process 900 may include adjusting, based at least in part on the TAC, a timing advance parameter associated with the corresponding TAG (block 940). For example, the UE (e.g., using communication manager 1108 and/or adjustment component 1112, depicted in FIG. 11) may adjust, based at least in part on the TAC, a timing advance parameter associated with the corresponding TAG, as described above.

Process 900 may include additional aspects, such as any single aspect or any combination of aspects described below and/or in connection with one or more other processes described elsewhere herein.

In a first aspect, determining the corresponding TAG associated with the TAC is based at least in part on the corresponding TAG being at least one of associated with a first TAG identifier, associated with a lowest TAG identifier, a PTAG, or associated with a first CORESET pool index.

In a second aspect, alone or in combination with the first aspect, process 900 includes receiving, in a CORESET, a PDCCH order triggering the random access procedure.

In a third aspect, alone or in combination with one or more of the first and second aspects, determining the corresponding TAG associated with the TAC is based at least in part on the corresponding TAG being associated with a CORESET pool index that is associated with the CORESET in which the PDCCH order is received.

In a fourth aspect, alone or in combination with one or more of the first through third aspects, determining the corresponding TAG associated with the TAC is based at least in part on the corresponding TAG being associated with a TCI state that is associated with the CORESET in which the PDCCH order is received.

In a fifth aspect, alone or in combination with one or more of the first through fourth aspects, determining the corresponding TAG associated with the TAC is based at least in part on the corresponding TAG being associated with an SS/PBCH index that is indicated by the PDCCH order.

In a sixth aspect, alone or in combination with one or more of the first through fifth aspects, determining the corresponding TAG associated with the TAC is based at least in part on the corresponding TAG being associated with a PRACH occasion that is indicated by the PDCCH order.

In a seventh aspect, alone or in combination with one or more of the first through sixth aspects, determining the corresponding TAG associated with the TAC is based at least in part on a TAG indication field included in the PDCCH order.

In an eighth aspect, alone or in combination with one or more of the first through seventh aspects, the TAG indication field is indicated using a number of reserved bits of the PDCCH order.

In a ninth aspect, alone or in combination with one or more of the first through eighth aspects, determining the corresponding TAG associated with the TAC is based at least in part on a TAG indication field included in the RAR.

In a tenth aspect, alone or in combination with one or more of the first through ninth aspects, the TAG indication field is indicated using a reserved bit of the RAR.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE (e.g., UE 120), or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, a network entity, or another wireless communication device) using the reception component 1002 and the transmission component 1004. As further shown, the apparatus 1000 may include the communication manager 1108 (e.g., the communication manager 140). The communication manager 1108 may include a performance component 1010 among other examples.

In some aspects, the apparatus 1000 may be configured to perform one or more operations described herein in connection with FIG. 7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE 120 described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE 120 described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive, in a first cell, a PDCCH order, wherein the PDCCH order includes an indication identifying a second cell to which the PDCCH order applies, wherein the second cell is different from the first cell, and wherein the PDCCH order triggers a random access procedure associated with the second cell. The performance component 1010 may perform the random access procedure associated with the second cell based at least in part on the PDCCH order.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a UE (e.g., UE 120), or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, a network entity, or another wireless communication device) using the reception component 1102 and the transmission component 1104. As further shown, the apparatus 1100 may include the communication manager 1108 (e.g., communication manager 140). The communication manager 1108 may include one or more of a determination component 1110, or an adjustment component 1112, among other examples.

In some aspects, the apparatus 1100 may be configured to perform one or more operations described herein in connection with FIG. 7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE 120 described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE 120 described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE 120 described in connection with FIG. 2. In some aspects, the transmission component 1104 may be co-located with the reception component 1102 in a transceiver.

The transmission component 1104 may transmit, in a cell associated with multiple TAGs, a random access preamble communication associated with a random access procedure. The reception component 1102 may receive, in response to the random access preamble communication, an RAR communication, wherein the RAR communication includes an indication of a TAC. The determination component 1110 may determine a corresponding TAG, of the multiple TAGs, associated with the TAC. The adjustment component 1112 may adjust, based at least in part on the TAC, a timing advance parameter associated with the corresponding TAG. Moreover, the reception component 1102 may receive, in a CORESET, a PDCCH order triggering the random access procedure.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: receiving, in a first cell, a PDCCH order, wherein the PDCCH order includes an indication identifying a second cell to which the PDCCH order applies, wherein the second cell is different from the first cell, and wherein the PDCCH order triggers a random access procedure associated with the second cell; and performing the random access procedure associated with the second cell based at least in part on the PDCCH order.

Aspect 2: The method of Aspect 1, wherein the second cell is not configured with a corresponding CORESET or PDCCH.

Aspect 3: The method of any of Aspects 1-2, wherein the PDCCH order is associated with one of a DCI format 1_1 or a DCI format 1_2.

Aspect 4: The method of Aspect 3, wherein an FDRA field of the one of the DCI format 1_1 or the DCI format 1_2 is set as all ones.

Aspect 5: The method of any of Aspects 3-4, wherein a CRC of the one of the DCI format 1_1 or the DCI format 1_2 is scrambled with a C-RNTI associated with the UE.

Aspect 6: The method of any of Aspects 3-5, wherein the one of the DCI format 1_1 or the DCI format 1_2 indicates at least one of a random access preamble index, an uplink/supplemental uplink indicator, an SS/PBCH indicator, or a PRACH mask index.

Aspect 7: The method of any of Aspects 3-6, wherein the one of the DCI format 1_1 or the DCI format 1_2 includes a carrier indication field, and wherein the indication identifying the second cell is the carrier indication field.

Aspect 8: The method of Aspect 1, wherein the PDCCH order is associated with a DCI format 1_0.

Aspect 9: The method of Aspect 8, wherein the indication identifying the second cell is indicated using a number of reserved bits of the DCI format 1_0.

Aspect 10: A method of wireless communication performed by a UE, comprising: transmitting, in a cell associated with multiple TAGs, a random access preamble communication associated with a random access procedure; receiving, in response to the random access preamble communication, an RAR communication, wherein the RAR communication includes an indication of a TAC; determining a corresponding TAG, of the multiple TAGs, associated with the TAC; and adjusting, based at least in part on the TAC, a timing advance parameter associated with the corresponding TAG.

Aspect 11: The method of Aspect 10, wherein determining the corresponding TAG associated with the TAC is based at least in part on the corresponding TAG being at least one of associated with a first TAG identifier, associated with a lowest TAG identifier, a PTAG, or associated with a first CORESET pool index.

Aspect 12: The method of any of Aspects 10-11, further comprising receiving, in a CORESET, a PDCCH order triggering the random access procedure.

Aspect 13: The method of Aspect 12, wherein determining the corresponding TAG associated with the TAC is based at least in part on the corresponding TAG being associated with a CORESET pool index that is associated with the CORESET in which the PDCCH order is received.

Aspect 14: The method of any of Aspects 12-13, wherein determining the corresponding TAG associated with the TAC is based at least in part on the corresponding TAG being associated with a TCI state that is associated with the CORESET in which the PDCCH order is received.

Aspect 15: The method of any of Aspects 12-14, wherein determining the corresponding TAG associated with the TAC is based at least in part on the corresponding TAG being associated with an SS/PBCH index that is indicated by the PDCCH order.

Aspect 16: The method of any of Aspects 12-15, wherein determining the corresponding TAG associated with the TAC is based at least in part on the corresponding TAG being associated with a PRACH occasion that is indicated by the PDCCH order.

Aspect 17: The method of any of Aspects 12-16, wherein determining the corresponding TAG associated with the TAC is based at least in part on a TAG indication field included in the PDCCH order.

Aspect 18: The method of Aspect 17, wherein the TAG indication field is indicated using a number of reserved bits of the PDCCH order.

Aspect 19: The method of any of Aspects 10-18, wherein determining the corresponding TAG associated with the TAC is based at least in part on a TAG indication field included in the RAR.

Aspect 20: The method of Aspect 19, wherein the TAG indication field is indicated using a reserved bit of the RAR.

Aspect 21: An apparatus for wireless communication at a device, comprising a processor; memory coupled with the processor; and instructions stored in the memory and executable by the processor to cause the apparatus to perform the method of one or more of Aspects 1-9.

Aspect 22: A device for wireless communication, comprising a memory and one or more processors coupled to the memory, the one or more processors configured to perform the method of one or more of Aspects 1-9.

Aspect 23: An apparatus for wireless communication, comprising at least one means for performing the method of one or more of Aspects 1-9.

Aspect 24: A non-transitory computer-readable medium storing code for wireless communication, the code comprising instructions executable by a processor to perform the method of one or more of Aspects 1-9.

Aspect 25: A non-transitory computer-readable medium storing a set of instructions for wireless communication, the set of instructions comprising one or more instructions that, when executed by one or more processors of a device, cause the device to perform the method of one or more of Aspects 1-9.

Aspect 26: An apparatus for wireless communication at a device, comprising a processor; memory coupled with the processor; and instructions stored in the memory and executable by the processor to cause the apparatus to perform the method of one or more of Aspects 10-20.

Aspect 27: A device for wireless communication, comprising a memory and one or more processors coupled to the memory, the one or more processors configured to perform the method of one or more of Aspects 10-20.

Aspect 28: An apparatus for wireless communication, comprising at least one means for performing the method of one or more of Aspects 10-20.

Aspect 29: A non-transitory computer-readable medium storing code for wireless communication, the code comprising instructions executable by a processor to perform the method of one or more of Aspects 10-20.

Aspect 30: A non-transitory computer-readable medium storing a set of instructions for wireless communication, the set of instructions comprising one or more instructions that, when executed by one or more processors of a device, cause the device to perform the method of one or more of Aspects 10-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive, in a first cell, a physical downlink control channel (PDCCH) order, wherein the PDCCH order includes an indication identifying a second cell to which the PDCCH order applies, wherein the second cell is different from the first cell, and wherein the PDCCH order triggers a random access procedure associated with the second cell; and
perform the random access procedure associated with the second cell based at least in part on the PDCCH order.

2. The apparatus of claim 1, wherein the second cell is not configured with a corresponding control resource set (CORESET) or PDCCH.

3. The apparatus of claim 1, wherein the PDCCH order is associated with one of a downlink control information (DCI) format 1_1 or a DCI format 1_2.

4. The apparatus of claim 3, wherein a frequency domain resource assignment (FDRA) field of the one of the DCI format 1_1 or the DCI format 1_2 is set as all ones.

5. The apparatus of claim 3, wherein a cyclic redundancy check (CRC) of the one of the DCI format 1_1 or the DCI format 1_2 is scrambled with a cell radio network temporary identifier (C-RNTI) associated with the UE.

6. The apparatus of claim 3, wherein the one of the DCI format 1_1 or the DCI format 1_2 indicates at least one of a random access preamble index, an uplink/supplemental uplink indicator, a synchronization signal/physical broadcast channel (SS/PBCH) indicator, or a physical random access channel (PRACH) mask index.

7. The apparatus of claim 3, wherein the one of the DCI format 1_1 or the DCI format 1_2 includes a carrier indication field, and wherein the indication identifying the second cell is the carrier indication field.

8. The apparatus of claim 1, wherein the PDCCH order is associated with a downlink control information (DCI) format 1_0.

9. The apparatus of claim 8, wherein the indication identifying the second cell is indicated using a number of reserved bits of the DCI format 1_0.

10. An apparatus for wireless communication at a user equipment (UE), comprising:
a memory; and
one or more processors, coupled to the memory, configured to:
transmit, in a cell associated with multiple timing advance groups (TAGs), a random access preamble communication associated with a random access procedure;
receive, in response to the random access preamble communication, a random access response (RAR) communication, wherein the RAR communication includes an indication of a timing advance command (TAC);
determine a corresponding TAG, of the multiple TAGs, associated with the TAC; and
adjust, based at least in part on the TAC, a timing advance parameter associated with the corresponding TAG.

11. The apparatus of claim 10, wherein determining the corresponding TAG associated with the TAC is based at least in part on the corresponding TAG being at least one of associated with a first TAG identifier, associated with a lowest TAG identifier, a primary TAG (PTAG), or associated with a first control resource set (CORESET) pool index.

12. The apparatus of claim 10, wherein the one or more processors are further configured to receive, in a control resource set (CORESET), a physical downlink control channel (PDCCH) order triggering the random access procedure.

13. The apparatus of claim 12, wherein determining the corresponding TAG associated with the TAC is based at least in part on the corresponding TAG being associated with a CORESET pool index that is associated with the CORESET in which the PDCCH order is received.

14. The apparatus of claim 12, wherein determining the corresponding TAG associated with the TAC is based at least in part on the corresponding TAG being associated with a transmission configuration indicator (TCI) state that is associated with the CORESET in which the PDCCH order is received.

15. The apparatus of claim 12, wherein determining the corresponding TAG associated with the TAC is based at least in part on the corresponding TAG being associated with a synchronization signal/physical broadcast channel (SS/PBCH) index that is indicated by the PDCCH order.

16. The apparatus of claim 12, wherein determining the corresponding TAG associated with the TAC is based at least in part on the corresponding TAG being associated with a physical random access channel (PRACH) occasion that is indicated by the PDCCH order.

17. The apparatus of claim 12, wherein determining the corresponding TAG associated with the TAC is based at least in part on a TAG indication field included in the PDCCH order.

18. The apparatus of claim 17, wherein the TAG indication field is indicated using a number of reserved bits of the PDCCH order.

19. The apparatus of claim 10, wherein determining the corresponding TAG associated with the TAC is based at least in part on a TAG indication field included in the RAR.

20. The apparatus of claim 19, wherein the TAG indication field is indicated using a reserved bit of the RAR.

21. A method of wireless communication performed by a user equipment (UE), comprising:
receiving, in a first cell, a physical downlink control channel (PDCCH) order, wherein the PDCCH order includes an indication identifying a second cell to which the PDCCH order applies, wherein the second cell is different from the first cell, and wherein the PDCCH order triggers a random access procedure associated with the second cell; and
performing the random access procedure associated with the second cell based at least in part on the PDCCH order.

22. The method of claim 21, wherein the second cell is not configured with a corresponding control resource set (CORESET) or PDCCH.

23. The method of claim 21, wherein the PDCCH order is associated with one of a downlink control information (DCI) format 1_1 or a DCI format 1_2.

24. The method of claim 23, wherein the one of the DCI format 1_1 or the DCI format 1_2 includes a carrier indication field, and wherein the indication identifying the second cell is the carrier indication field.

25. The method of claim 21, wherein the PDCCH order is associated with a downlink control information (DCI) format 10, and wherein the indication identifying the second cell is indicated using a number of reserved bits of the DCI format 1_0.

26. A method of wireless communication performed by a user equipment (UE), comprising:
transmitting, in a cell associated with multiple timing advance groups (TAGs), a random access preamble communication associated with a random access procedure;
receiving, in response to the random access preamble communication, a random access response (RAR) communication, wherein the RAR communication includes an indication of a timing advance command (TAC);
determining a corresponding TAG, of the multiple TAGs, associated with the TAC; and
adjusting, based at least in part on the TAC, a timing advance parameter associated with the corresponding TAG.

27. The method of claim 26, wherein determining the corresponding TAG associated with the TAC is based at least in part on the corresponding TAG being at least one of associated with a first TAG identifier, associated with a lowest TAG identifier, a primary TAG (PTAG), or associated with a first control resource set (CORESET) pool index.

28. The method of claim 26, further comprising receiving, in a control resource set (CORESET), a physical downlink control channel (PDCCH) order triggering the random access procedure.

29. The method of claim 28, wherein determining the corresponding TAG associated with the TAC is based at least in part on a TAG indication field included in the PDCCH order.

30. The method of claim 26, wherein determining the corresponding TAG associated with the TAC is based at least in part on a TAG indication field included in the RAR.
